(19) United States
(12) Patent Application Publication
(10) Pub. No.: US 2026/0319821 A1
(43) Pub. Date: Oct. 15, 2026

(54) PROVISIONING VIRTUAL MACHINE IMAGES IN A CLOUD COMPUTING ENVIRONMENT

(71) Applicant: FMR LLC, Boston, MA (US)

(72) Inventors: Raghu Kumar Thukral, Apex, NC (US); James Dooney, Somerville, MA (US); Jason A. Custodio, Manchester, NH (US)

(21) Appl. No.: 19/174,532

(22) Filed: Apr. 9, 2025

(51) Int. Cl. G06F 9/455

(52) U.S. Cl. CPC G06F 9/45558; G06F 2009/45562

(57) ABSTRACT

Methods and apparatuses for provisioning virtual machine images in a cloud computing environment include a server that creates a virtual machine image for deployment to the cloud environment. The virtual machine image comprises software resources associated with an operating system and a database platform. The server executes image build automation instruction files for each of the software resources to build the virtual machine image using source code packages. The server validates the execution of the image build automation instruction files and encrypts the virtual machine image in association with a source cloud account. The server publishes the encrypted virtual machine image, including deploying the encrypted virtual machine image to a new virtual machine instance provisioned in a first region of the cloud environment. The server verifies operation of the new virtual machine instance using a test pipeline and enables access to the new virtual machine instance from remote computing devices.

### TECHNICAL FIELD

This application relates generally to methods and apparatuses, including computer program products, for provisioning virtual machine images in a cloud computing environment.

### BACKGROUND

Significant advances in computing and network technology over the last decade have contributed to the rise of cloud computing services and platforms. These cloud computing services enable enterprises to deploy and host their computing systems, applications, and related services (e.g., web servers, database servers, application servers) in a remote, shared, and often virtualized computing environment (i.e., using virtual machine instances that are created using images or snapshots) that does not need to be actively managed by the enterprise. Enterprises can thus take advantage of the immense computing power, memory storage, network bandwidth, and other highly scalable resources provided by such cloud computing services to provide a more flexible and efficient computing infrastructure for its employees and customers.

As a result, many enterprises have sought to automate deployment of key data processing applications and services—such as database management platforms like Azure Cloud Factory™ from Microsoft Corp.—to cloud environments. This endeavor has led to some technical challenges and obstacles. In one example, an enterprise may utilize application-or organization-specific database configurations or deployment pipelines for provisioning a virtual machine in a cloud computing environment. Often, there are no tools available in the cloud computing platform to accomplish provisioning and deployment of the database management platform in an automated manner—for example, the cloud platform may not support deployment of pipelines or supporting infrastructure (e.g., virtual machines, endpoints, linked services) without appropriate owner or user approval. Therefore, manual, time-intensive and resource-intensive steps must be taken to both complete the initial provisioning and deployment, and to undertake ongoing maintenance and monitoring of the database management platform—which can lead to delays, errors, and lack of repeatability for such actions. In addition, the cloud computing platform may not have the out-of-the-box capability to integrate with other existing, on-premises enterprise systems (e.g., authentication, data security, application and network monitoring).

### SUMMARY

Therefore, what is needed are methods and systems for enabling automated creation, deployment, and testing of virtual machine images (VMIs) deployed to virtual machines (VMs) in multiple regions of a cloud computing environment. Beneficially, the techniques described herein enable customized virtual machine images to be deployed to specific accounts or regions in the cloud environment, for access and interaction by endpoint devices and end users. Furthermore, the methods and systems described herein advantageously provide solutions for deploying, provisioning, and managing cloud-based VMs automatically, overcoming the lack of existing tools to accomplish such tasks. The techniques described herein advantageously enable a framework of provisioning, managing, monitoring, and rehydrating database instances and their associated virtual computing resources through centralized pipelining and automated continuous integration (CI)/continuous deployment (CD) processes, onboarding of such cloud computing resources to an identity authentication service, and allowing for resiliency, failover, and site swapping to deliver seamless and uninterrupted availability of critical data processing resources.

The invention, in one aspect, features a system for provisioning virtual machine images in a cloud computing environment. The system comprises a server computing device having a memory for storing computer-executable instructions and a processor that executes the computer-executable instructions. The server computing device creates a virtual machine image for deployment to a cloud computing environment coupled to the server computing device. The virtual machine image comprises software resources associated with (i) an operating system and (ii) a database platform. The server computing device executes image build automation instruction files for each of the software resources to build the virtual machine image using one or more source code packages retrieved from a source code repository. The server computing device validates the execution of the image build automation instruction files. The server computing device encrypts the virtual machine image in association with a source cloud account in the cloud computing environment. The server computing device publishes the encrypted virtual machine image in the cloud computing environment, including deploying the encrypted virtual machine image to a new virtual machine instance provisioned in a first region of the cloud computing environment, the new virtual machine instance associated with a target cloud account in the cloud computing environment. The server computing device verifies operation of the new virtual machine instance in the cloud computing environment using a test pipeline. The server computing device enables access to the new virtual machine instance from one or more remote computing devices.

The invention, in another aspect, features a computerized method of provisioning virtual machine images in a cloud computing environment. A server computing device creates a virtual machine image for deployment to a cloud computing environment coupled to the server computing device. The virtual machine image comprises software resources associated with (i) an operating system and (ii) a database platform. The server computing device executes image build automation instruction files for each of the software resources to build the virtual machine image using one or more source code packages retrieved from a source code repository. The server computing device validates the execution of the image build automation instruction files. The server computing device encrypts the virtual machine image in association with a source cloud account in the cloud computing environment. The server computing device publishes the encrypted virtual machine image in the cloud computing environment, including deploying the encrypted virtual machine image to a new virtual machine instance provisioned in a first region of the cloud computing environment, the new virtual machine instance associated with a target cloud account in the cloud computing environment. The server computing device verifies operation of the new virtual machine instance in the cloud computing environment using a test pipeline. The server computing device enables access to the new virtual machine instance from one or more remote computing devices.

Any of the above aspects can include one or more of the following features. In some embodiments, the virtual machine image further comprises software resources associated with (iii) a data replication service. In some embodiments, executing image build automation instruction files comprises selecting, from the source code repository, a corresponding image build automation instruction file for each of the software resources; and executing each of the identified image build automation instruction files in a defined sequence to build the virtual machine image, including compiling one or more of the source code packages identified in the image build automation instruction file into the virtual machine image. In some embodiments, validating the execution of the image build automation instruction files comprises, for each image build automation instruction file: determining that the image build automation instruction file completed execution; and identifying any errors that occurred during execution of the image build automation instruction file before executing the next image build automation instruction file in the defined sequence. In some embodiments, the server computing device cancels execution of subsequent image build automation instruction files in the defined sequence when at least one error is identified during execution of the image build automation instruction file. In some embodiments, the server computing device generates a build error log comprising the at least one error and transmits an electronic communication to a remote computing device that includes the build error log.

In some embodiments, encrypting the virtual machine image in association with a source cloud account in the cloud computing environment comprises generating an encryption key for the source cloud account and encrypting the virtual machine image using the encryption key for the source cloud account. In some embodiments, deploying the encrypted virtual machine image to the new virtual machine instance comprises sharing the encrypted virtual machine image with the target cloud account; copying a snapshot of the encrypted virtual machine image to the target cloud account; and launching the new virtual machine instance using the snapshot the encrypted virtual machine image.

In some embodiments, verifying operation of the new virtual machine instance in the cloud computing environment using a test pipeline comprises performing one or more operational tests defined in the test pipeline against the new virtual machine instance; and identifying any errors that occurred in the new virtual machine instance during performance of the operational tests. In some embodiments, the server computing device generates a test error log comprising the identified errors and transmits an electronic communication to a remote computing device that includes the test error log. In some embodiments, the server computing device captures, from a user interface of a client computing device, a build and deployment configuration that defines operations to be performed during the creation of the virtual machine image, the publishing of the encrypted virtual machine image, and the verification of the operation of the new virtual machine instance. In some embodiments, upon completing the verification of the operation of the new virtual machine instance, the server computing device generates a report comprising identification of the software resources included in the virtual machine image.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for provisioning virtual machine images in a cloud computing environment.

FIG. 2 is a flow diagram of a computerized method of provisioning virtual machine images in a cloud computing environment.

FIG. 3 is a diagram of an exemplary user interface for initiating virtual machine image creation, publishing, and/or testing.

FIG. 4 is a diagram of a portion of an exemplary package structure for creation of a virtual machine image.

FIG. 5 is a diagram of a portion of a list of binaries incorporated into a new virtual machine image.

FIG. 6 is a diagram of a user interface that displays virtual machine image build progress.

FIG. 7 is a diagram of a user interface that displays virtual machine image publication progress.

### DETAILED DESCRIPTION

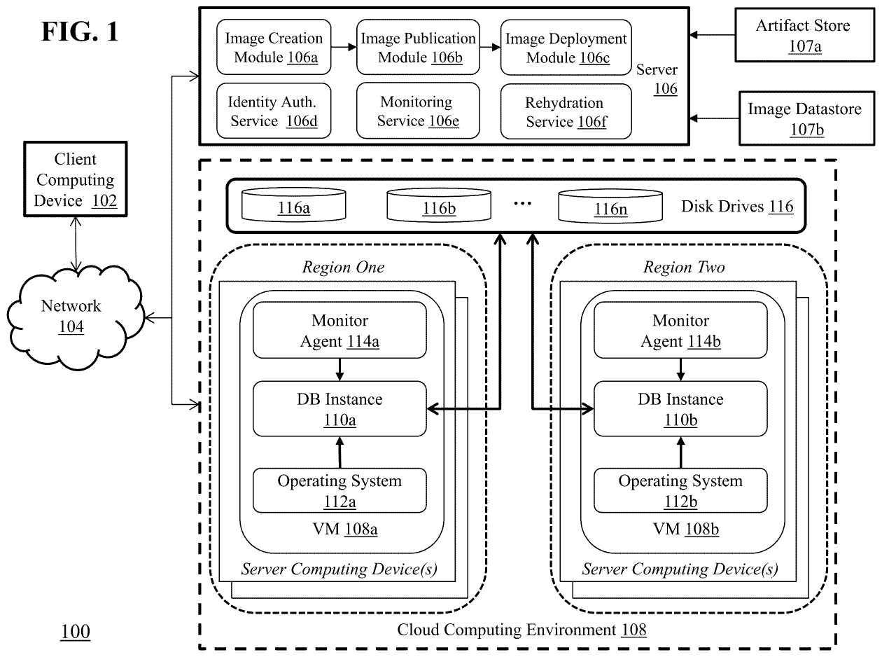

FIG. 1 is a block diagram of system 100 for provisioning virtual machine images in a cloud computing environment. System 100 includes client computing device 102 that is coupled via communications network 104 to server computing device 106 and cloud computing environment 108. Server computing device 106 includes image creation module 106a, image publication module 106b, image deployment module 106c, identity authentication service 106d, monitoring service 106e, and rehydration service 106f. Server computing device 106 is coupled to artifact store 107a and image datastore 107b. Cloud computing environment 108 includes a plurality of virtual machines (VMs) 108a, 108b executing on one or more server computing devices in different regions in cloud computing environment 108. Generally and without limitation, virtual machines 108a, 108b are created in cloud computing environment 108 by deploying a virtual machine image into a container or other virtual computing resource. A virtual machine image (VMI) comprises one or more software resources that make up a template of a pre-configured system—including, but not limited to, an operating system, applications (e.g., database instances), libraries, configuration files, and other data that are installed and configured according to the requirements of a specific workload. VM 108a in Region One includes database (DB) instance 110a, operating system 112a, and monitor agent 114a. VM 108b in Region Two includes DB instance 110b, operating system 112b, and monitor agent 114b. Cloud computing environment 108 further includes one or more physical disk drives 116a-116n (collectively, 116).

Client computing device 102 connects to communications network 104 in order to communicate with server computing device 106 and cloud computing environment 108 to provide input and receive output relating to the process of provisioning virtual machine images in a cloud computing environment as described herein. Client computing device 102 can be coupled to a display device (not shown). For example, client computing device 102 can provide a detailed graphical user interface (GUI) via the display device that presents output resulting from the methods and systems described herein, where the GUI is utilized by an operator to review and monitor VMI status information, including but not limited to VMI creation status, VMI publication status, and VMI deployment status provided by server computing device 106 and/or cloud computing environment 108.

Exemplary client devices 102 include but are not limited to desktop computers, laptop computers, tablets, mobile devices, smartphones, and internet appliances. It should be appreciated that other types of computing devices that can connect to the components of system 100 can be used without departing from the scope of invention. Although FIG. 1 depicts a single client computing device 102, it should be appreciated that system 100 can include any number of client devices.

Communication network 104 enables the other components of system 100 to communicate with each other in order to perform the process of provisioning virtual machine images in a cloud computing environment as described herein. Network 104 may be a local network, such as a LAN, or a wide area network, such as the Internet and/or a cellular network. In some embodiments, network 104 is comprised of several discrete networks and/or sub-networks (e.g., cellular to Internet) that enable the components of the system 100 to communicate with each other.

Server computing device 106 is a combination of hardware, including one or more special-purpose processors and one or more physical memory modules, and specialized software modules—such as modules 106a-106f—that are executed by a processor of server computing device 106, to receive data from other components of system 100, transmit data to other components of system 100, and perform functions for provisioning virtual machine images in a cloud computing environment as described herein. In some embodiments, modules 106a-106f are specialized sets of computer software instructions programmed onto a dedicated processor in server computing device 106 and can include specifically designated memory locations and/or registers for executing the specialized computer software instructions. Further explanation of the specific processing performed by modules 106a-106f will be provided below.

Artifact store 107a and image datastore 107b comprise transient and/or persistent memory for data storage, that is used in conjunction with the process of provisioning virtual machine images in a cloud computing environment as described herein. Generally, artifact store 107a comprises software application code files, artifacts, libraries, configuration files, metadata, and other elements that make up one or more of the software applications contained in software application images. Generally, image datastore 107b comprises software application images (also called virtual machine images) that can be deployed into VMs 108a, 108b in cloud computing environment 108 so that one or more remote computing devices can connect to the VMs 108a, 108b and access application functionality. In some embodiments, all or a portion of artifact store 107a and/or image datastore 107b can be integrated within server computing device 106 or be located on a separate computing device or devices. In some embodiments, artifact store 107a and/or image datastore 107b are hosted on one or more remote computing devices (e.g., cloud-based architecture) that are accessible to server computing device 106.

Cloud computing environment 108 is a combination of hardware, including one or more special-purpose processors and one or more physical memory modules, and specialized software—such as virtual machines (VMs) 108a, 108b—that are executed by processor(s) of one or more server computing devices in cloud computing environment 108, to receive data from other components of system 100, transmit data to other components of system 100, and perform functions for provisioning virtual machine images in a cloud computing environment as described herein. Each VM 108a, 108b comprises a database (DB) instance 110a, 110b, an operating system 112a, 112b, and a monitor agent 114a, 114b. In some embodiments, elements 110a-110b, 112a-112b, and 114a-114b comprise software modules, such as one or more containers instantiated within virtual machines 108a, 108b, that include a plurality of files and configuration information (i.e., software code, environment variables, libraries, other dependencies, and the like). Cloud computing environment 108 can be configured to execute many virtual machine instances 108a, 108b in isolation from each other. In some embodiments, cloud computing environment 108 executes each VM 108a, 108b and/or the component elements 110a-110b, 112a-112b, and 114a-114b in a separate OS process, and constrains each element's access to physical resources (e.g., CPU, memory) of the corresponding server computing device so that a single VM 108a-108b does not utilize all of the available physical resources. Upon execution, one or more server computing devices in cloud computing environment 108 executes application code and data stored in VMs 108a-108b for delivery, configuration, monitoring, presentation, and/or manipulation of application functions and associated data contained in, e.g., DB instances 110a, 110b by one or more endpoint devices. In one embodiment, cloud computing environment 108 is deployed using a commercially available cloud computing platform. As shown in FIG. 1, the resources of cloud computing environment 108 can be distributed into a plurality of regions which can be defined according to certain geographic and/or technical performance requirements. Each region can comprise one or more datacenters connected via a regional network that meets specific low-latency requirements. Inside each region, cloud computing environment 108 can be partitioned into one or more availability zones (AZ), which are physically separate locations used to achieve tolerance to, e.g., hardware failures, software failures, disruption in connectivity, unexpected events/disasters, and the like. Typically, the availability zones are connected using a high-performance network (e.g., round trip latency of less than two milliseconds). It should be appreciated that other types of computing resource distribution and configuration in a cloud environment can be used within the scope of the technology described herein.

Cloud computing environment 108 also comprises a plurality of disk drives 116a-116n (collectively, 116)—one or more of which are coupled to the database instances 110 a, 110 b of platforms 108a, 108b. Disk drives 116a-116n comprise physical disk drives (e.g., hard disk drives (HDD) and/or solid-state drives (SSD)) that are used by VMs 108a, 108b to store data elements associated with database instances 110a,110b. In the example of a cloud computing environment, these disk drives 116a-116n can be managed/shared disks used by a plurality of different resources or computing devices. Typically, a database instance 110a, 110b is attached to a particular disk drive 116a when initialized and is detached from the disk drive when one or more of the VM 108a, 108b and/or the database instance 110a, 110b is removed, updated, reinitialized, or rehydrated.

In some embodiments, the deployed VMs 108a, 108b (i.e., resources 110a-110b, 112, and 114a-114b) in the cloud environment 108 are integrated with identity authentication service 106d of server computing device 106. To ensure seamlessness and uniformity of access control in the cloud environment, it is desirable to synchronize user accounts between a local identity authentication service and the cloud environment 108. This also enables users to access DB instances 110a, 110b according to the specific permissions/roles assigned to them in the on-premises system. In some embodiments, identity authentication service 106d is configured to establish a link relationship between a user of the identity authentication service in the on-premises environment and a corresponding cloud representation of the user (that is maintained by the cloud service provider). The configuration of the cloud environment 108 enables each of the components of the VMs 108a, 108b to access the user access information when responding to requests (e.g., data read/write/update requests, application execution, etc.) that require access to data (e.g., via disk drives 116). Then, when access changes are made to the users in identity authentication service of the on-premises environment, those changes are synchronized automatically to the cloud environment 108.

In some embodiments, VMs 108a, 108b are configured according to a disaster recovery (DR) architecture. For example, VM 108a with DB instance 110a can operate as the main active platform which receives data requests from endpoint devices or other computing devices in a live production environment. VM 108b with DB instance 110b can operate as a standby platform which does not receive active production data requests. Instead, in the event of an outage, hardware failure or other technical incident affecting the normal operation of VM 108a, active production traffic is re-routed to VM 108b so that end users experience uninterrupted access to the data stored and maintained in DB instances 110a, 110b. As part of the DR architecture, it is necessary to ensure that certain data files associated with DB instances 110a, 110b are synchronized between the respective regions, so that DB instance 110a is replicated to DB instance 110b without suffering from missing or incomplete data.

As can be appreciated, a benefit of implementing resources and services in a cloud computing environment is the ability to create redundancy and failover infrastructures so that critical enterprise data pipelines and applications do not experience any interruptions in service. During initial deployment and/or during subsequent updates, provisioning module 106a can configure the cloud environment 108 (including VMS 108a, 108b and corresponding elements 110a-110b, 112, and 114a-114b) according to any of a number of different high availability patterns so that data processing features and pipelines remain consistent and able to be accessed across different platforms and/or regions in cloud computing environment 108.

In one example, VM 108a may experience an error or technical problem that prevents normal operation (e.g., failure of cloud hardware, network connectivity issues, etc.). In such events, it is crucial to seamlessly swap from VM 108a in one region to another VM 108b (also called site switching) in a different region so that system operation and availability is not affected. In some embodiments, the site switching process includes the requirement to disable a first database instance (e.g., 110a) in the VM that is experiencing problems and enable corresponding database instance(s) (e.g., 110b) in another VM.

As can be appreciated, such high availability patterns provide several technical advantages to the overall system 100. Once a high availability pattern is set up, monitoring service 106e of server computing device 106 connects to each of the platform monitor agents 114a, 114b deployed in cloud environment 108 to monitor each of the corresponding VMs 108a, 108b. For example, monitoring service 106c can actively track characteristics of the VMs 108a, 108b and their associated computing resources in cloud computing environment 108, such as functional status, memory load, data errors, network connectivity, bandwidth, processing overhead, usage, data processing requests, online/offline status, and the like. In some embodiments, monitoring service 106e can receive one or more log files generated by platform monitor agents 114a, 114b and analyze the log files to determine the above characteristics as part of the monitoring process.

In some embodiments, each region of the cloud computing environment 108 can include an event manager agent provisioned to capture usage and performance metrics for the DB instances 110a, 110b. Each event manager agent can be coupled to monitoring service 106e for transmission of the usage and performance metrics to monitoring service 106e for analysis. For example, the event manager agent can capture data relating to, e.g., user connections, transaction load (e.g., reads/writes), data errors, transaction latency, and other types of database statistics. In some embodiments, the functions of the event manager agent can be combined with the platform monitor agent 114a, 114b that is deployed in the corresponding VM.

Upon detecting an undesirable or adverse condition of one or more of the VMs 108a, 108b (such as a computing resource failure) and/or the database instances 110a, 110b (such as a data read/write error), monitoring service 106c can redirect traffic from the failing VM 108a in one region to another VM 108b in another region in order to maintain continuity of data processing availability and system functionality. In some embodiments, monitoring service 106e can additionally transmit alert messages received from one or more of platform monitor agents 114a, 114b via an established connection when a failure event occurs at the associated VMs 108a, 108b. The alert message can be transmitted to, e.g., an end user device such as client computing device 102 so that system administrators and other personnel can be informed of the service interruption. Alert messages can also be generated and transmitted by monitoring service 106e in the event that failures or errors are detected at one or more disk drives 116 and/or other system resources that are connected to cloud environment 108.

In addition to the above features, the systems and methods described herein provide for seamless updating of resources and elements 110a, 110b, 112a, 112b, 114a, and 114b of the virtual machines 108a-108b through a process of rehydration. As can be appreciated, existing deployed VMs may require periodic or emergency software updates (e.g., when configuration updates are required, when a new database or supporting software version and/or operating system version is released, when a data resource is changed, when a new security patch is released, etc.)—this process may require creation, publishing, testing and deployment of a new or updated virtual machine image. Rehydration service 106f can be configured to initiate a rehydration process to refresh a virtual machine image associated with VMs 108a, 108b in cloud computing environment 108. In some embodiments, the user at client computing device 102 can interact with rehydration service 106f to initiate the rehydration process. In other embodiments, rehydration service 106f periodically analyzes the virtual machine image and related software resources utilized in each VM 108a, 108b and determines when to initiate rehydration (e.g., a new software version, database version, or OS version is released; a security patch is ready for implementation, etc.).

Rehydration service 106f detects that one or more of VMs 108a, 108b and/or one or more computing resources within the VMs 108a, 108b needs to be updated. For example, when a new version of software associated with a virtual machine image that has been deployed to VMs 108a, 108b is released, image creation module 106c can be configured to determine that the current version of the operating system software deployed in VM 108a, 108b is out of date (e.g., by comparing a build number, version number, or other similar indicia). In another example, rehydration service 106f can be configured to determine that a code base associated with VM 108a, 108b has been modified (e.g., via a build instruction or other indicia from a code development management system and/or issue tracking ticket system). A common rehydration process is to update software associated with VM 108a, 108b periodically to ensure the latest patches and functionality is contained in VM 108a, 108b.

To begin the rehydration process, rehydration service 106f detaches the physical disk drive 116a-116n from the corresponding database instance 110a, 110b in the VM 108a, 108b that is being refreshed. Next, rehydration service 106f deletes one or more virtual computing resource(s) (e.g., software modules, linked services, libraries, OS components) in the VM 108a, 108b that will be updated via rehydration. In some embodiments, rehydration service 106f can stop/remove the VM 108a, 108b from cloud computing environment 108 and deploy a new VM (with updated software) using the same computing resources that were allocated for the VM that was removed.

Rehydration service 106f then deploys one or more updated software resources in the corresponding VM 108a, 108b. In some embodiments, rehydration service 106f uses updated resource images (i.e., newer or changed virtual machine images that are different from those originally used to create the VM 108a, 108b). For example, rehydration service 106f can deploy the new software or services in the VM 108a, 108b using an updated virtual machine software image file (e.g., an operating system image file or a security patch image file) that was created to deploy the new version of the software and/or virtual computing resource(s) in cloud environment 108. After the new virtual computing resource is created in VM 108a, 108b, rehydration service 106f restarts the updated VM 108a, 108b. After rehydration is complete, rehydration service 106f re-attaches the physical data resources (i.e., disk drives 116 that were previously detached) to the corresponding database instance 110a, 110b in the restarted VM 108a, 108b.

Upon deploying a VM, image deployment module 106c can validate the deployment to confirm that all components of the VM are installed and functioning correctly in the cloud computing environment 108. In some embodiments, the deployment pipeline script executed by image deployment module 106c includes one or more validation steps—whereby module 106c issues requests to cloud computing environment 108 (including but not limited to platforms 108a, 108b and/or the associated elements 110a-110b, 112a-11b, 114a-114b) to confirm that the VM is operating as expected. In some embodiments, image deployment module 106c can compile and transmit a validation report to a remote computing device (e.g., client computing device 102) that includes deployment details and information on the results of the deployment validation.

As can be appreciated, system 100 of FIG. 1 can advantageously implement automated workflows and processes to accomplish virtual machine image creation, deployment as VMs in cloud computing environment, and validation as described herein, instead of relying on manually invoked jobs and user-based monitoring and intervention to allocate computing resources, infrastructure, and security requirements needed to instantiate new VMs in cloud computing environment 108.

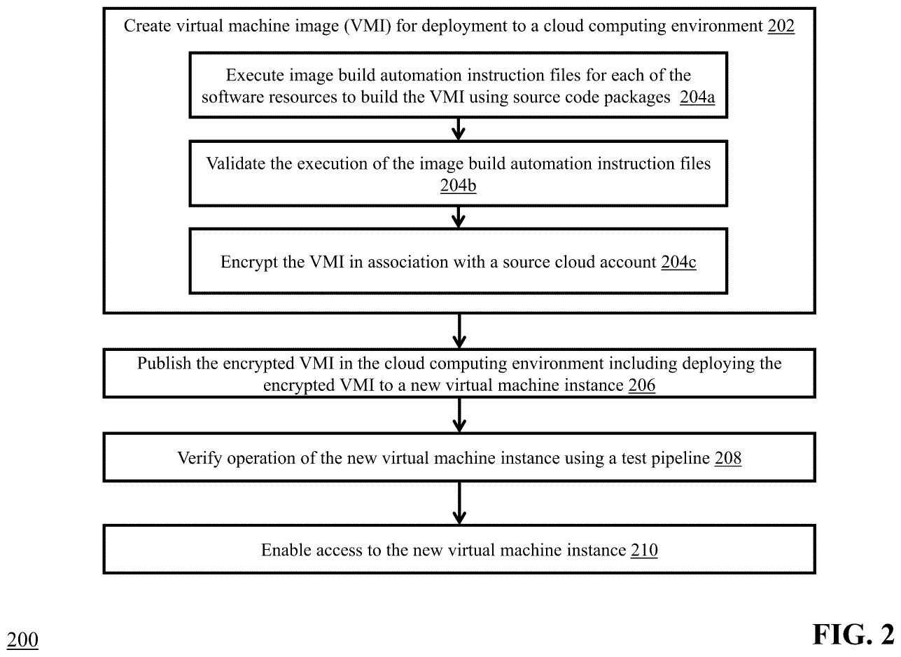

FIG. 2 is a flow diagram of a computerized method 200 of provisioning virtual machine images in a cloud computing environment, using system 100 of FIG. 1. In one example, a user at client computing device 102 establishes a connection to server computing device 106 via network 104 to initiate the creation of a virtual machine image that can be deployed in cloud computing environment 108 as a virtual machine 108a, 108b.

In some embodiments, the user at client computing device 102 launches a virtual machine image creation and deployment tool that is either installed on client computing device 102 or made available by server computing device 106. For example, the user at client computing device 102 can open browser software and enter an address (e.g., URL) that points to a web-based interface provided by server computing device 106. The web-based interface can receive a request from client computing device 102 via the URL and respond with a graphical user interface (e.g., webpage) that is presented on client computing device 102 which enables the user to request creation of a new virtual machine image for deployment in cloud computing environment 108 and/or perform other configuration or maintenance operations (e.g., rehydration, software versioning, security monitoring) for VMs 108a, 108b. In one embodiment, image creation module 106a determines a role of the user at client computing device 102 (e.g., using authentication credentials and/or a user profile provided by the client computing device) and enables user access to software features (e.g., code files, binaries, libraries, etc.) that, when executed, generate a new virtual machine image for deployment in cloud environment 108. Using the VMI creation and deployment tool, the user can initiate one or more VMI creation, deployment, and validation automation pipeline workflows to be used in establishing VMs 108a, 108b. Exemplary VMI creation and deployment tools include but are not limited to DevOps automation tools, such as Jenkins™ (available at www.jenkins.io) and/or UrbanCode Deploy™ (uDeploy) (available at www.urbancode.com/product/deploy), which enable the user to create a VMI, publish the VMI to the cloud computing environment 108, and validate the operation of the VMI as deployed in a virtual machine in the cloud environment.

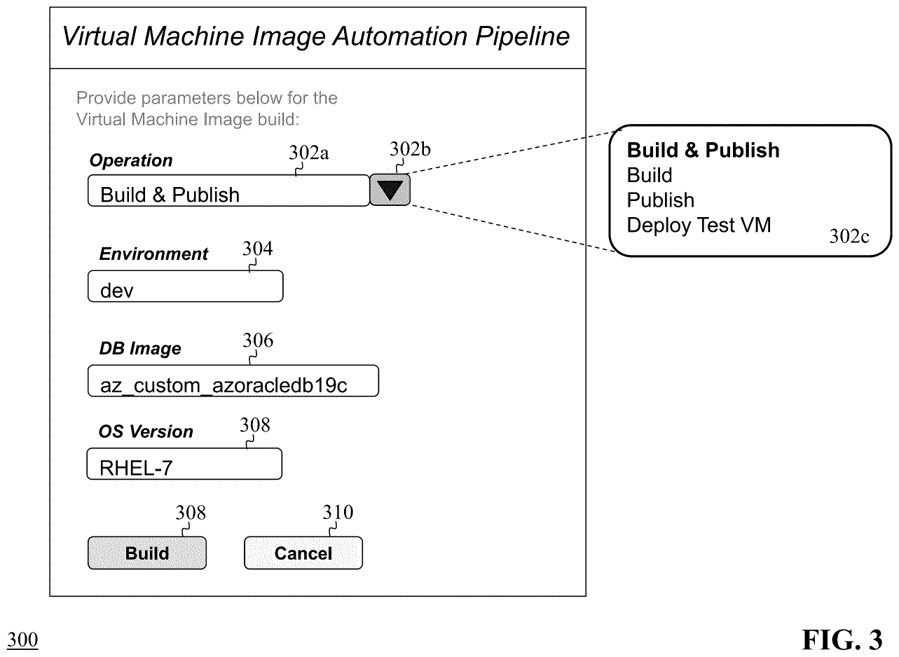

FIG. 3 is a diagram of an exemplary user interface (UI) 300 for initiating virtual machine image creation, publishing, and/or testing, as generated by server computing device 106 for display on client computing device 102. As shown in FIG. 3, user interface 300 includes drop down menu 302a that enables a user of client computing device 102 to select an operation type associated with the virtual machine image. For example, the user can interact with button 302b to open menu 302c which enables the user to select one of a plurality of different VMI operations—Build & Publish (i.e., create a new VMI and publish the VMI to the cloud environment), Build (i.e., create a new VMI), Publish (i.e., publish a VMI to the cloud environment), or Deploy Test VM (i.e., generate a VM in cloud environment with the VMI and verify operation). It should be appreciated that the options listed in menu 302c are merely exemplary, and other types of operations can be contemplated within the scope of technology described herein.

User interface 300 also includes input area 304 that enables the user to identify to which area of cloud computing environment 108 the VMI should be published. As shown in FIG. 3, the user has identified a development (‘dev’) environment. Other types of environments can include, but are not limited to, testing (‘test’) environments, pre-production (‘preprod’) environments, and/or production (‘prod’) environments. User interface 300 also includes input area 306 that enables the user to identify a specific database (DB) image that should be included in the VMI. In this example, the user has selected a customized Oracle™ 19c database platform (‘oracledb19c’) for the Microsoft® Azure™ cloud environment (‘az’). Other types of images can include, but are not limited to, Oracle 19c database platform for the Amazon® AWS™ cloud environment (‘awsoracledb19c’), and Oracle™ GoldenGate™ data replication software with the Oracle™ 19c database platform for Amazon® AWS™ cloud environment (‘awsoraclegg19c’). User interface 300 also includes input area 308 that enables the user to identify a specific operating system (OS) version that should be included in the VMI. In this example, the user has selected the Red Hat Enterprise Linux™ (RHEL) version 7 operating system (‘RHEL-7’). Other types of operating systems can include, but are not limited to, Red Hat Enterprise Linux (RHEL) version 8 (‘RHEL-8’). The user can then interact with the Build button 308 to initiate creation of a new VMI based upon the parameters they have provided in the UI 300. Alternatively, the user can interact with the Cancel button 310 to close the UI 300 without creating a new VMI.

Turning back to FIG. 2, image creation module 106a of server computing device 106 receives the data input by the user in UI 300 and creates (step 202) a virtual machine image for deployment to cloud computing environment 108. The virtual machine image comprises software resources associated with (i) an operating system and (ii) a database platform. Using the example of FIG. 3, the operating system resources are for RHEL version 7 and the database platform resources are for Oracle 19c. The process of creating a virtual machine image includes the following steps.

At step 204a, image creation module 106a executes image build automation instruction files for each of the software resources to build the virtual machine image using one or more source code packages retrieved from a source code repository. In some embodiments, image creation module 106a identifies and connects to a source code repository (e.g., artifact store 107a) for each of the software resources (e.g., DB image, OS version) selected by the user in UI 300, where the source code repository stores the corresponding files, packages, binaries, libraries and other resources necessary to create the VMI. An exemplary source code repository is GitHub™ (github.com). In some embodiments, image creation module 106a can also connect to image datastore 107b to, e.g., allocate space, generate metadata, and otherwise prepare for storing a snapshot of the VMI under creation. Image creation module 106a also collects one or more image build automation instruction files that will be used to create the VMI. In some embodiments, the image build automation instruction files are stored in artifact store 107a in connection with the source code packages.

In some embodiments, the image build automation instruction files comprise one or more automation task lists which enable the automatic building of virtual machine images from code files, binaries, and packages. The task lists can be used each time a new virtual machine image is created for deployment in cloud environment 108. As an example, the automation task lists can be configured as Ansible® Playbooks that image creation module 106a automatically executes to build the VMI. Ansible, available from Red Hat Inc., is a software framework that enables infrastructure as code (IaC) for application deployment and cloud provisioning. In some embodiments, each database image and operating system version (as selected in UI 300) is associated with a different automation task list that contains an identified sequence of code packages, binaries, and files that need to be included in the VMI that is being created. When image creation module 106a can use the DB image identifier 306 and the OS version identifier 308 from UI 300 to locate corresponding automation task list(s) for creating the VMI. In some embodiments, the automation task lists for VMI creation can be stored in artifact store 107a and/or image datastore 107b.

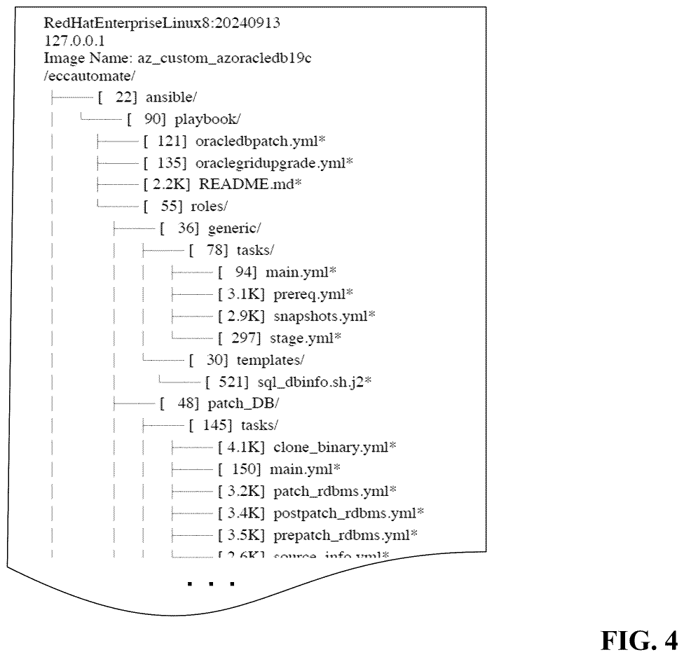

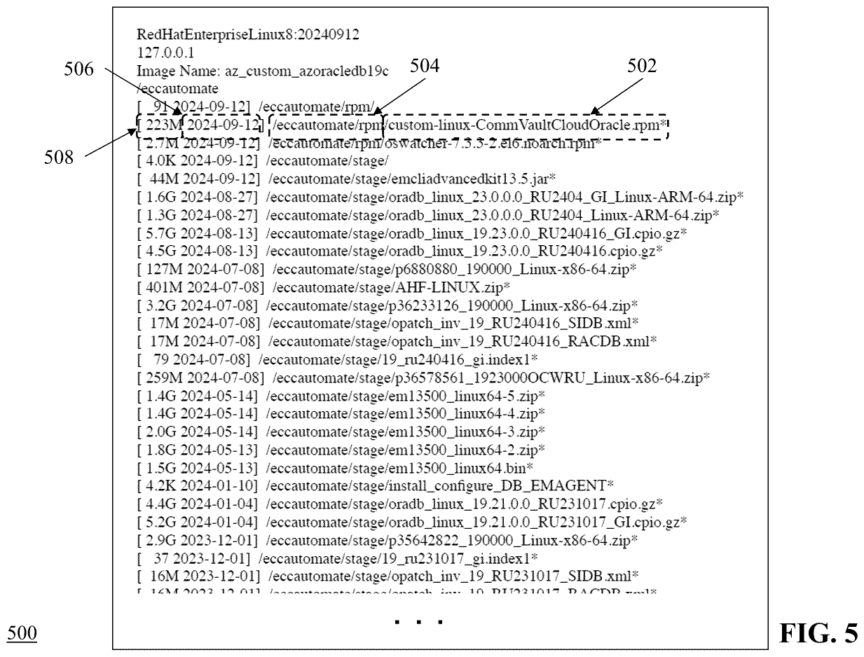

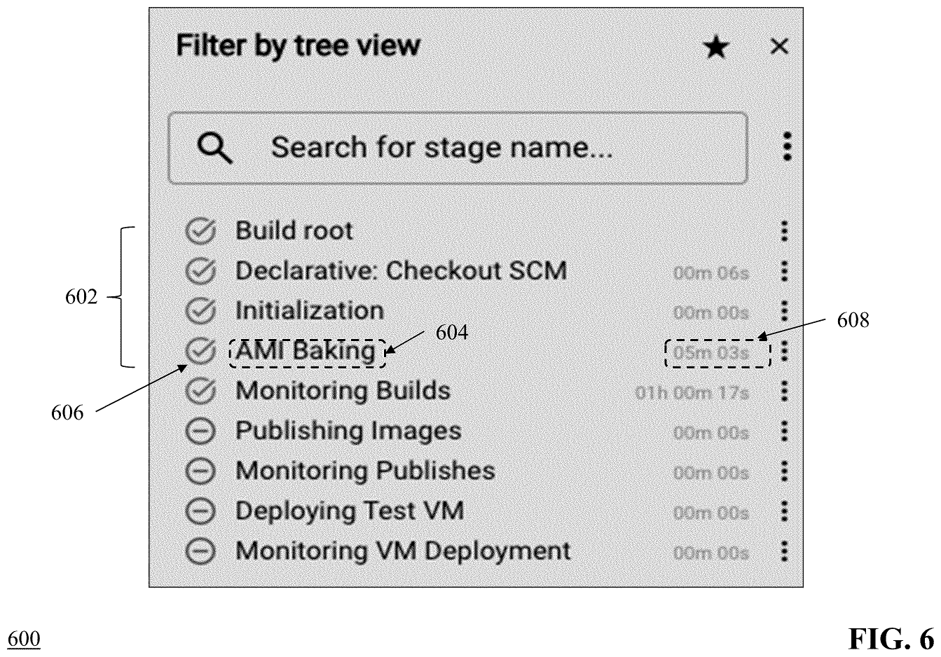

Image creation module 106a executes the automation task lists for the VMI build by executing each task in the list in order and, for each software package identified in the task list, performing one or more functions to incorporate the software package into the VMI. In some embodiments, image creation module 106a can traverse a directory structure in the source code repository to retrieve one or more files that are copied and/or compiled into the virtual machine image. In some embodiments, image creation module 106a can execute one or more binaries that are unpackaged and installed into the virtual machine image. FIG. 4 is a diagram of a portion of an exemplary package structure 400 for creation of a virtual machine image that includes a RHEL version 8 operating system and an Oracle 19c database instance. As shown in FIG. 4, the package structure 400 identifies specific files/binaries that are incorporated into a new VMI by image creation module 106 executing an automation task list. FIG. 5 is a diagram of a portion of a corresponding list of binaries 500 incorporated into the new VMI by image creation module 106a. As shown in FIG. 5, the list of binaries 500 identifies the software package 502 (e.g., ‘custom-linux-CommVaultCloudOracle.rpm*’), a directory location 504 (e.g., ‘/eccautomate/rpm/), a timestamp 506 (e.g., 2024Sept. 12) and a file size 508 (e.g., ‘223M’). In some embodiments, image creation module 106a generates one or more log files during the VMI build process—including but not limited to reports comprising the information in FIG. 4 and/or 5—and can transmit the log files to one or more remote computing devices after building the VMI. In addition, during the VMI creation process, image creation module 106a can generate a user interface for display on client computing device 102 that shows a user the current progress of the VMI build. FIG. 6 is a diagram of a user interface 600 that displays VMI build progress to a user of client computing device 102. As shown in FIG. 6, UI 600 displays a list of build events 602 each of which includes the event name 604, an indicator of completion 606 (e.g., checkmark means the step is complete), and a time associated with execution of the event 608.

In some embodiments, the image build automation instruction files are executed in a defined sequence when building the VMI. For example, in order to build the operating system aspect of the VMI, image creation module 106a can execute an Ansible playbook comprised of a plurality of tasks that are each triggered in a specific sequence. As can be appreciated, multiple Ansible playbooks may need to be executed to complete the creation of a VMI. Once image creation module 106a has executed all of the image build automation instruction files for the virtual machine image being created, the VMI can be stored in image datastore 107b.

At step 204b, image creation module 106a validates the execution of image build automation instruction files for the VMI. As mentioned above, image creation module 106a can generate log files associated with execution of the image build automation instruction files, where the log files contain information relating to the status of execution of image build automation instruction files. Image creation module 106a scans the log files to identify where any execution errors occurred, and which task lists and/or specific code packages had errors. For example, the log file can include an entry for each package that is being deployed, along with indicia of whether the deployment completed successfully or not. In some embodiments, the indicia comprise a binary flag or value (e.g., true or false). In some embodiments, the indicia comprise an error code or text string that corresponds to the specific error. Image creation module 106a validates the execution of the image build automation instruction files for the VMI when no errors are detected in the corresponding log files. In the event that one or more errors occurred during creation of the VMI, image creation module 106a can terminate the VMI build and transmit a build error log to, e.g., client computing device 102 for user review.

In some embodiments, image creation module 106a is configured to validate the execution of each image build automation instruction file in the sequence as soon as module 106a has completed execution of the instruction file. If execution of a particular image build automation instruction file fails, image creation module 106a can cancel execution of subsequent image build automation instruction files in the defined sequence when at least one error is identified during execution of the image build automation instruction file.

At step 204c, when the VMI build has completed successfully, image creation module 106a encrypts the VMI in association with a source cloud account. In some embodiments, the source cloud account comprises a central account that belongs to the organization subscribing to the cloud environment 108 for the purpose of creating and publishing VMIs in the cloud environment 108 for use by endpoint devices/end users. The central account enables the organization to connect and authenticate to, and access, the computing resources in the cloud environment 108. In some embodiments, the central account is associated with an encryption key that is used to encrypt data for storage in the cloud computing environment 108. Typically, the encryption key is unique to the central account. In some embodiments, the encryption key is generated using a service-managed key (SMK) model, where the cloud computing environment 108 manages the encryption key and encrypts data as it is received for storage. In some embodiments, the encryption key is generated using a customer-managed key (CMK) model or bring-your-own-key (BYOK) model, where the data is encrypted before it is sent to the cloud computing environment 108 for storage. For example, image creation module 106a can encrypt the VMI using the encryption key and then create the encrypted VMI in the central account in cloud computing environment 108 for publication and deployment.

Once the encrypted VMI has been created, the VMI can be published in cloud environment 108 to enable downstream devices/users to access a virtual machine 108a, 108b that contains the VMI. It should be appreciated that not every VMI created or stored in the cloud environment 108 must be published.

At step 206, module 106b publishes the encrypted VMI in the cloud environment 108 including deploying the encrypted VMI to a new virtual machine instance provisioned in a particular region of the cloud environment. In some embodiments, image publication module 106b initializes a new virtual machine instance (e.g., VM 108a, 108b) in a particular region of cloud computing environment 108 and deploys the VMI into the new VM instance—including instantiating the operating system 112a, 112b resources and the database instance 110a, 110b resources in the virtual machine 108a, 108b using the encrypted virtual machine image. In some embodiments, once the VM 108a, 108b is set up in cloud environment and operating system 112a, 112b is installed, image publication module 106b deploys the DB instance 110a, 110b.

In some embodiments, the new virtual machine 108a, 108b created by image publication module 106b is associated with a target cloud account in cloud environment 108. The target account is a different account from the central account and, in some embodiments, the target account is associated with a specific end user, category of end users, and/or endpoint device(s) that will access the virtual machine 108a, 108b. In some embodiments, the target account can be defined in identity authentication service 106d according to one or more roles, access permissions, or credentials. For a publication of the VMI in an Azure™ cloud environment, image publication module 106b can copy the encrypted VMI to a central subscription account where the VMI is accessed by end users. For a publication of the VMI in an AWS™ cloud environment, image publication module 106b can copy the encrypted VMI to a plurality of provided accounts associated with end users.

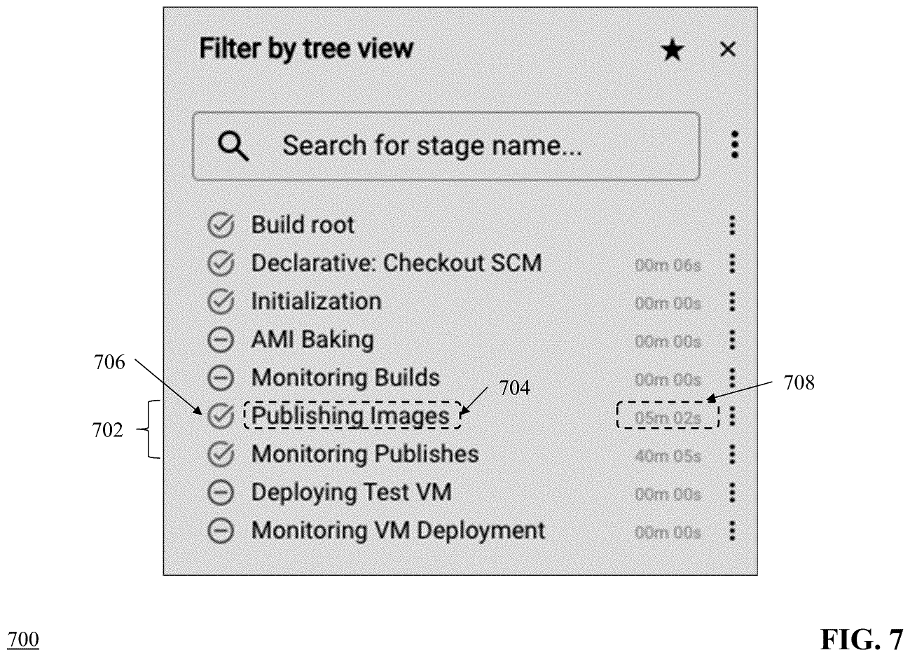

As an example, publication of the VMI can include sharing the encrypted VMI with the target cloud account, copying a snapshot of the encrypted VMI to the target cloud account; and launching the new virtual machine instance 108a, 108b using the snapshot of the encrypted virtual machine image. In some embodiments, the snapshot is a copy of the encrypted VMI in a given state (e.g., power state) and/or with specific data (e.g., files, disks, memory, other devices). The snapshot can be used as the basis for a point-in-time restoration of the VM 108a, 108b or to troubleshoot issues. FIG. 7 is a diagram of a user interface 700 that displays VMI publication progress to a user of client computing device 102. As shown in FIG. 7, UI 700 displays a list of publication events 702 each of which includes the event name 704, an indicator of completion 706 (e.g., checkmark means the step is complete), and a time associated with execution of the event 708.

After the VMI is published to a VM 108a, 108b in a target cloud account in the cloud computing environment 108, image deployment module 106c verifies that the virtual machine image installed in the VM 108a, 108b is able to operate successfully by performing one or more integrity validation tests and/or one or more operational validation tests on the VM. In some embodiments, image deployment module 106c is configured to execute a test pipeline that is defined with one or more tests to confirm that the VM 108a, 108b as a whole and/or the specific components within the VM 108a, 108b (such as DB instances 110a, 110b) are complete and operating as expected. In some embodiments, image deployment module 106c executes the integrity validation tests by issuing one or more instructions to the VM 108a, 108b that request the VM 108a, 108b to return specific data (e.g., version numbers of installed software, information associated with resource allocation, networking or connectivity verification) that indicates the VM 108a, 108b is active and accessible. In some embodiments, image deployment module 106c executes the operational validation tests by issuing one or more instructions to the VM 108a, 108b that trigger the execution of specific functionality of the software installed in the VM 108a, 108b. For example, an operational validation test may comprise instructions that cause DB instance 110a, 110b to execute a query and retrieve data. Image deployment module 106c can verify that the VM is operating normally when the DB instance 110a, 110b successfully returns the expected data in response to the instructions. It should be appreciated that, in some embodiments, image deployment module 106c can carry out the validation testing described above using an automated, script-based approach. For example, image deployment module 106c can be configured to store one or more scripts that comprise a series of instructions to automatically carry out the test pipeline.

Image deployment module 106c can identify any errors that occurred in the new virtual machine instance during performance of the integrity tests and/or operational tests in the pipeline. For example, one or more of the tests may fail to complete due to errors raised by VM 108a, 108b resulting from an incomplete or invalid deployment of the VMI and/or instantiation of the VM. In these cases, module 106c can detect and log the test errors for display in a test error log to, e.g., a user at client computing device 102.

At step 210, upon successful verification of the operation of VMs 108a, 108b, image deployment module 106c enables access to the new virtual machine instance (e.g., VMs 108a, 108b) from one or more remote computing devices. The remote computing devices can connect to the VMs 108a, 108b in cloud computing environment 108 and interact with the installed software resources. If the result of the testing performed against VMs 108a, 108b indicates that the VMI was not deployed successfully, module 106c can determine that the VM should not be made available for access by remote computing devices.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS™, Microsoft® Azure™, Google® Cloud™, IBM® Cloud™). A cloud computing environment includes a collection of computing resources provided as a service to one or more remote computing devices that connect to the cloud computing environment via a service account—allowing access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for provisioning virtual machine images in a cloud computing environment, the system comprising a server computing device having a memory for storing computer-executable instructions and a processor that executes the computer-executable instructions to:
create a virtual machine image for deployment to a cloud computing environment coupled to the server computing device, the virtual machine image comprising software resources associated with (i) an operating system and (ii) a database platform, including:
executing image build automation instruction files for each of the software resources to build the virtual machine image using one or more source code packages retrieved from a source code repository,
validating the execution of the image build automation instruction files, and
encrypting the virtual machine image in association with a source cloud account in the cloud computing environment;
publish the encrypted virtual machine image in the cloud computing environment, including deploying the encrypted virtual machine image to a new virtual machine instance provisioned in a first region of the cloud computing environment, the new virtual machine instance associated with a target cloud account in the cloud computing environment;
verify operation of the new virtual machine instance in the cloud computing environment using a test pipeline; and
enable access to the new virtual machine instance from one or more remote computing devices.

2. The system of claim 1, wherein the virtual machine image further comprises software resources associated with (iii) a data replication service.

3. The system of claim 1, wherein executing image build automation instruction files comprises:
selecting, from the source code repository, a corresponding image build automation instruction file for each of the software resources; and
executing each of the identified image build automation instruction files in a defined sequence to build the virtual machine image, including compiling one or more of the source code packages identified in the image build automation instruction file into the virtual machine image.

4. The system of claim 3, wherein validating the execution of the image build automation instruction files comprises, for each image build automation instruction file:
determining that the image build automation instruction file completed execution; and
identifying any errors that occurred during execution of the image build automation instruction file before executing the next image build automation instruction file in the defined sequence.

5. The system of claim 4, wherein the server computing device cancels execution of subsequent image build automation instruction files in the defined sequence when at least one error is identified during execution of the image build automation instruction file.

6. The system of claim 5, wherein the server computing device generates a build error log comprising the at least one error and transmits an electronic communication to a remote computing device that includes the build error log.

7. The system of claim 1, wherein encrypting the virtual machine image in association with a source cloud account in the cloud computing environment comprises:
generating an encryption key for the source cloud account;
encrypting the virtual machine image using the encryption key for the source cloud account.

8. The system of claim 7, wherein deploying the encrypted virtual machine image to the new virtual machine instance comprises:
sharing the encrypted virtual machine image with the target cloud account;
copying a snapshot of the encrypted virtual machine image to the target cloud account; and
launching the new virtual machine instance using the snapshot the encrypted virtual machine image.

9. The system of claim 1, wherein verifying operation of the new virtual machine instance in the cloud computing environment using a test pipeline comprises:
performing one or more operational tests defined in the test pipeline against the new virtual machine instance; and
identifying any errors that occurred in the new virtual machine instance during performance of the operational tests.

10. The system of claim 9, wherein the server computing device generates a test error log comprising the identified errors and transmits an electronic communication to a remote computing device that includes the test error log.

11. The system of claim 1, wherein the server computing device captures, from a user interface of a client computing device, a build and deployment configuration that defines operations to be performed during the creation of the virtual machine image, the publishing of the encrypted virtual machine image, and the verification of the operation of the new virtual machine instance.

12. The system of claim 1, wherein upon completing the verification of the operation of the new virtual machine instance, the server computing device generates a report comprising identification of the software resources included in the virtual machine image.

13. A computerized method of provisioning virtual machine images in a cloud computing environment, the method comprising:
creating, by a server computing device, a virtual machine image for deployment to a cloud computing environment coupled to the server computing device, the virtual machine image comprising software resources associated with (i) an operating system and (ii) a database platform, including:
executing image build automation instruction files for each of the software resources to build the virtual machine image using one or more source code packages retrieved from a source code repository,
validating the execution of the image build automation instruction files, and
encrypting the virtual machine image in association with a source cloud account in the cloud computing environment;
publishing, by the server computing device, the encrypted virtual machine image in the cloud computing environment, including deploying the encrypted virtual machine image to a new virtual machine instance provisioned in a first region of the cloud computing environment, the new virtual machine instance associated with a target cloud account in the cloud computing environment;
verifying, by the server computing device, operation of the new virtual machine instance in the cloud computing environment using a test pipeline; and
enabling, by the server computing device, access to the new virtual machine instance from one or more remote computing devices.

14. The method of claim 13, wherein the virtual machine image further comprises software resources associated with (iii) a data replication service.

15. The method of claim 13, wherein executing image build automation instruction files comprises:
selecting, from the source code repository, a corresponding image build automation instruction file for each of the software resources; and
executing each of the identified image build automation instruction files in a defined sequence to build the virtual machine image, including compiling one or more of the source code packages identified in the image build automation instruction file into the virtual machine image.

16. The method of claim 15, wherein validating the execution of the image build automation instruction files comprises, for each image build automation instruction file:
determining that the image build automation instruction file completed execution; and
identifying any errors that occurred during execution of the image build automation instruction file before executing the next image build automation instruction file in the defined sequence.

17. The method of claim 16, further comprising canceling, by the server computing device, execution of subsequent image build automation instruction files in the defined sequence when at least one error is identified during execution of the image build automation instruction file.

18. The method of claim 17, further comprising generating, by the server computing device, a build error log comprising the at least one error and transmitting an electronic communication to a remote computing device that includes the build error log.

19. The method of claim 13, wherein encrypting the virtual machine image in association with a source cloud account in the cloud computing environment comprises:
generating an encryption key for the source cloud account;
encrypting the virtual machine image using the encryption key for the source cloud account.

20. The method of claim 19, wherein deploying the encrypted virtual machine image to the new virtual machine instance comprises:
sharing the encrypted virtual machine image with the target cloud account;
copying a snapshot of the encrypted virtual machine image to the target cloud account; and
launching the new virtual machine instance using the snapshot the encrypted virtual machine image.

21. The method of claim 13, wherein verifying operation of the new virtual machine instance in the cloud computing environment using a test pipeline comprises:
performing one or more operational tests defined in the test pipeline against the new virtual machine instance; and
identifying any errors that occurred in the new virtual machine instance during performance of the operational tests.

22. The method of claim 21, further comprising generating, by the server computing device, a test error log comprising the identified errors and transmits an electronic communication to a remote computing device that includes the test error log.

23. The method of claim 13, further comprising capturing, by the server computing device, from a user interface of a client computing device, a build and deployment configuration that defines operations to be performed during the creation of the virtual machine image, the publishing of the encrypted virtual machine image, and the verification of the operation of the new virtual machine instance.

24. The method of claim 13, further comprising generating, by the server computing device upon completing the verification of the operation of the new virtual machine instance, a report comprising identification of the software resources included in the virtual machine image.
